(19) United States
(12) Patent Application Publication
(10) Pub. No.: US 2011/0178683 A1
(43) Pub. Date: Jul. 21, 2011

(54) METHOD AND CONTROL DEVICE FOR DETECTING A LATERAL AND/OR A ROOF POSITION OF A VEHICLE

(76) Inventors: Alfons Doerr, Stuttgart (DE); Volker Walz, Sersheim (DE); Stephan Rittler, Urbach (DE)

(21) Appl. No.: 13/003,445

(22) PCT Filed: May 12, 2009
(86) PCT No.: PCT/EP2009/055709

§ 371 Date: Apr. 8, 2011

(30) Foreign Application Priority Data
Jul. 9, 2008 (DE) 102008040295.8

(51) Int. Cl. B60R 21/0132; G06F 15/00

(52) U.S. Cl. 701/45; 701/1; 702/141

(57) ABSTRACT

A method for detecting a lateral position and/or a roof position of a vehicle, the method including a first step of receiving a lateral value and/or a vertical value via an interface, the lateral value representing a lateral acceleration and/or the vertical value representing a vertical acceleration. Furthermore, the method has a second step of detecting the roof position of the vehicle when a position value derived from the vertical value is greater in absolute terms, at least in one component, than a predefined vertical threshold value, and/or the method has a step of detecting the lateral position of the vehicle when a position value derived from the vertical value and the lateral value is located in a lateral position region of a state space, the state space being plotted by axes with regard to a lateral and a vertical acceleration.

### FIELD OF THE INVENTION

The present invention relates to a method and a control device for detecting a lateral position and/or a roof position of a vehicle.

### BACKGROUND INFORMATION

Due to the increasing number of restraining devices in passenger protection (e.g., seat-belt pretensioners, multi-stage airbags, etc.) the requirements for the associated triggering algorithm are becoming increasingly complex. Not least, the adaptability of restraining devices (e.g., multi-stage airbags, active venting) requires an algorithm that calculates different crash severities and different crash types from the available sensor signals (crash discrimination) or is able to recognize crash situations in detail. To minimize the system costs, it is desirable for the triggering algorithm to make do with information from as few sensors as possible.

One conventional method for detecting crashes relates to the use of acceleration signals that are separated with the aid of characteristic curves.

German Patent Application No. DE 102006019316 A1 describes a device for triggering passenger protection devices, the device having a mechanism for recording a plurality of driving dynamics data, as well as a passenger compartment sensor system and an evaluation circuit. The evaluation circuit triggers passenger protection devices so as to prevent a vehicle occupant from being ejected, the signal of the passenger compartment sensor system and the plurality of driving dynamics data being taken into account in the process.

### SUMMARY

In accordance with the present invention, an example method is provided for detecting a lateral and/or roof position of a vehicle, the method including the following steps:
receiving the lateral and/or vertical value via an interface, the lateral value representing a lateral acceleration and/or the vertical value representing a vertical acceleration;
detecting the roof position of the vehicle if the vertical value or a position value derived from the vertical value is greater in absolute terms, at least in one component, than a predefined vertical threshold value, and/or detecting the lateral position of the vehicle if a position value derived from the vertical value and the lateral value is located in a lateral position region of a state space, the state space being defined by axes relative to a lateral and a vertical acceleration.

In accordance with an additional specific embodiment of the present invention, a control device having mechanisms for implementing the above method or a variant of it is provided.

According to the present invention, it is possible to detect a rollover in a simple manner from the signals of the acceleration sensors in the lateral and/or vertical direction. It is thus possible to determine a rollover in a simple manner with the aid of an evaluation of the vertical value, without having to revert to data of a roll rate sensor. To detect a lateral position of the vehicle, the values of these signals are linked, and this link is interpreted in the form of a position value in a state space. This evaluation using the state space thus allows for a lateral position of the vehicle to be determined in a manner that is markedly more precise than the threshold-value-based evaluation of individual signals, since not only the individual acceleration signals but also additionally different combinations of the values of these two acceleration signals (or values derived therefrom) are taken into account. For this purpose, the lateral position region of the state space is defined as a region that ranges across a region of the occurring maximum and minimum lateral acceleration values, since the greatest probability for a lateral position of the vehicle is found in this region. However, in this regard one must be mindful of the fact that the method according to the example embodiment of the present invention builds only on lateral and vertical values that were already available, and that these values do not necessarily have to be provided first by the example method according to the present invention. For this reason, it is sufficient for the lateral and vertical values merely to be made available (i.e., received) via an arbitrarily designed interface.

An advantage of the present invention is that it is only necessary to provide signals of acceleration sensors in the lateral direction (that is, y direction) and/or vertical direction (that is, z direction), which also provide control pulses for the central airbag control device, for example. Thus, sensors that usually already exist in the vehicle can be used further. The rolling motion of the vehicle during the rollover does not need to be detected, so that it also is not necessary to provide a roll rate sensor in the vehicle. The rollover detection is focused only on determining that a vehicle rollover has occurred (for example, in the preliminary stages). Thus, the functionality of the rollover detection is able to be implemented using minimal sensor equipment because the roll rate sensors that are otherwise required for the rollover detection are not necessary. Furthermore, the robustness of the situation detection increases as the accident duration progresses, since a temporal evaluation of the dwell time of the position value in a region of the state space is also possible. Thus, the detection of the position of the vehicle becomes more reliable as the temporal length of the evaluation increases. An additional advantage of the present invention is that it is not only possible to detect post-crash situations in which the vehicle is on its side or in a roof position, but also, in principle, it is possible to detect a preceding 360° rotation by evaluating the position value. This means that in post-crash states in which the vehicle stands on its wheels again after a rollover, the vehicle rollover may also be detected subsequently. Through the separation of the different post-crash states, different measures may thus be taken.

In order to implement a simple evaluation of a rollover, which usually occurs in a rolling motion, in one favorable specific embodiment of the present invention, the position value may be determined by using a circle equation in the detection step. By this means, the position value in the state space describes a circular path, so that the lateral position region and a roof position region in which at least one component of the position value is greater than the vertical threshold value may be simply marked in the state space. A detection of the position of the vehicle is thus simplified.

In the step of detecting the lateral position, it is also favorable to use a lateral position region in the state space whose components in the direction of a vertical acceleration have a lower absolute value than the vertical threshold value. This allows for a clear indication of whether the vehicle is in a lateral position or a roof position, in order to be able to introduce correspondingly suitable measures.

In an additional specific embodiment of the present invention, a lateral position region divided into a first and a second partial region is used in the step of detecting the lateral position, in order to detect that the vehicle is lying on the first side when the position value is in the first partial region and to detect that the vehicle is lying on the second side, which is opposite the first side, when the position value is in the second partial region, the components of the first partial region in the direction of the lateral acceleration having a different sign than the corresponding components of the second partial region. This provides the advantage that it is not only possible to detect that the vehicle is lying on its side, but also on which side the vehicle is lying. Accordingly, it is then possible to implement different safety measures, such as specifically releasing and/or opening the accessible (i.e., exposed) doors.

Also, in accordance with another specific embodiment of the present invention, a position value that takes into account a lateral offset value for the lateral value and/or that takes into account a vertical offset value for the vertical value may be used in the detection step. By this means, it is possible to compensate a falsification of the position detection, for example, through the gravitational acceleration that exists in general or a lateral acceleration in the event of cornering, so that essentially the rollover motion is extracted from the signals of the corresponding acceleration sensors.

During the detection step, it is particularly favorable if the lateral position is detected when the position value is in the lateral position region of the space state for a predefined lateral-position time period, and/or if the roof position is detected when the vertical value or the position value assumes a value that is greater than the vertical threshold value in at least one component for a predefined roof-position time period. This ensures that the vehicle has stabilized in the detected position state (i.e., on its side or on its roof), when the vertical value or the position value remains in the corresponding lateral-position region or roof-position region in the state space, at least for the corresponding lateral-position time period or the roof-position time period. This allows for a more reliable detection of the vehicle situation after an accident, so that the respectively appropriate safety functionality (which is possibly triggered irreversibly) can also be activated in a useful manner.

Furthermore, it is also possible to detect an upright position of the vehicle in the detection step, when the position value has been in the lateral position region, but is no longer in the lateral position region after the predefined lateral-position time period, and/or when at least one component of the vertical value or the position value has taken on a value greater than the vertical threshold value, but after the predefined roof-position time period the at least one component has taken on a value that is no longer greater than the vertical threshold value. Through such an evaluation of the dwell time of the position value in the lateral position region and the roof position region, it is thus also possible to detect a preceding rollover, in which the vehicle has flipped over back into the normal position, however. Such a rollover with subsequent flipping over back into the normal position of the vehicle also requires particular precautionary measures though, since the vehicle doors could be jammed due to the rollover, for example, and a special release of these doors or a switching on of the passenger compartment lighting of the vehicle may possibly assist a rescue of the passengers.

One specific embodiment of the present invention is particularly favorable in which in the step of detecting the lateral position and/or of detecting the roof position, the lateral position and/or the roof position are detected only if the position value is located within a predefined ring-shaped region in the state space. This ring-shaped region may be a plausibility region in the state space, in which the position values in the ring-shaped region may be achieved by physically possible sensor data combinations in the event of a rollover. Thus, if a position value that is not within the ring-shaped region is ascertained, it is highly probable that an error occurred during the determination of the position value, and that a reliable position detection of the vehicle is not possible.

Furthermore, if a lateral position and/or a roof position was/were detected in the detection step, a step may be taken to activate a safety function. For example, activating the safety function may include opening the door locks, triggering passenger compartment lighting of the vehicle, and/or stopping the vehicle motor. Such an activating of a safety device immediately after detecting the position of the vehicle offers the advantage that the safety and the possibility of rescuing persons after an accident may be significantly increased.

Furthermore, according to one specific embodiment of the present invention, it is possible that in the step of receiving the lateral and/or vertical value, these values are received by a value memory for the lateral and/or the vertical value. This allows for vehicle movement to be evaluated in the offline operation, for example, when passenger safety is to be improved in a resting position of the vehicle (for example, lying on its side or on its roof) after safety functions such as airbags have been triggered. This can be achieved by simply evaluating the signals (or variables derived therefrom) of already existing sensors, so that no cost-intensive additional equipping of the vehicle is necessary.

Also, in accordance with one specific embodiment of the present invention, a computer program having program code for implementing steps of one of the preceding methods may be provided when the computer program is executed on a data processing system. In particular, a microprocessor, a microcontroller, a digital signal processor, an application-specific integrated circuit (ASIC), or a similar electronic component may be used as a data processing system. By this arrangement, the required calculations may be efficiently performed numerically or by circuit engineering.

### BRIEF DESCRIPTION OF THE DRAWINGS

Below, the present invention is explained more precisely by way of example, with reference to the figures.

FIG. 1 shows a schematic block diagram of an exemplary embodiment of the present invention.

FIG. 2 shows a representation of the functional principle of the detection of the roof position of a vehicle using a state space.

FIG. 3 shows a representation of the functional principle of the detection of the lateral position of a vehicle using the state space.

FIG. 4 shows a flow chart of a further exemplary embodiment of the present invention as a method.

Possibly indicated dimensions and measures are only exemplary such that the present invention is not limited to these dimensions and measures. Identical or similar elements are labeled with identical or similar reference symbols. Furthermore, the figures and their description contain numerous features in combination. In this context, it is clear to one skilled in the art that these features may also be considered individually or may be combined to form further combinations not explicitly described here.

### DETAILED DESCRIPTION OF EXAMPLE EMBODIMENTS

The present invention is used to achieve the objective of detecting a post-crash situation, among other things. In particular, the post-crash situation in which the vehicle is situated on its roof or its side after a rollover is to be detected.

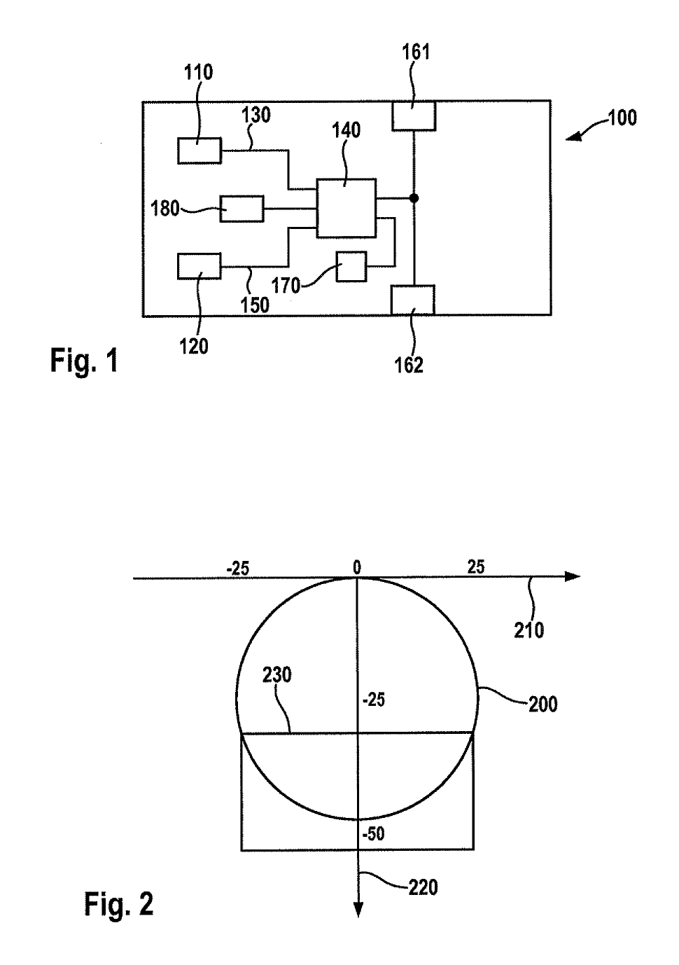

For this purpose, a vehicle 100 may include a first acceleration sensor 110 and a second acceleration sensor 120, as shown in FIG. 1. First acceleration sensor 110 may be designed to measure a lateral or horizontal acceleration of vehicle 100, whereas second acceleration sensor 120 may be designed to detect a vertical acceleration of vehicle 100. In particular in the event of a rotation of vehicle 100 around its longitudinal axis, vertical acceleration components always occur that may be detected using second acceleration sensor 120. First acceleration sensor 110 outputs a first acceleration signal 130 that corresponds to the lateral acceleration and whose value is supplied to a data processing system 140 as a lateral value and is processed there. Analogously, second acceleration sensor 120 may be designed to output a second acceleration signal 150 corresponding to the vertical acceleration, whose value is likewise supplied to data processing system 140 as a vertical value and is processed there. The data processing system may be any electronic component, for example, a microcontroller, a microprocessor, a digital signal processor, an application-specific integrated circuit (ASIC), or a similar electronic component, which can process the lateral and vertical values in a numerical way or by circuit engineering. Data processing unit 140 may also be implemented as a control device that has, among other things, a functionality to trigger an airbag or another passenger restraining device before or during the accident in response to the lateral and/or vertical value. Thus, first and second acceleration sensors 110 and 120 may be part of an airbag triggering circuit whose data may be further used for the present invention, however.

In accordance with one exemplary embodiment of the present invention, data processing unit 140 is designed to detect a position of the vehicle from the lateral value and the vertical value of acceleration sensors 110 and 120 (which already exist for other safety functions of a vehicle, for example), in order to be able to activate additional safety means or to introduce safety measures. In particular, it is possible for data processing unit 140 to detect a lateral position and/or a roof position of the vehicle after a rollover using the method described below in greater detail. After detecting a lateral position of vehicle 100, for example, a release signal may be sent to a first door lock 161 and/or to a second door lock 162 in order to unlock the corresponding doors of vehicle 100. In this way, it is possible to ensure that rescue crews more easily reach a person trapped in the passenger compartment. Furthermore, alternatively or additionally, data processing unit 140 can provide a signal for switching on a vehicle passenger compartment lighting 170, in order to make it easier for a person in vehicle 100 to orient himself on the one hand, and on the other hand in the event of darkness to alert rescue crews to vehicle 100 involved in the accident through the greater illuminated area in the passenger compartment of the vehicle. Additionally or alternatively, data processing unit 140 can also switch off motor 180 of vehicle 100 if a lateral position and/or a roof position of the vehicle is detected, so that arriving rescue crews are not endangered by wheels of vehicle 100 that continue to spin, so that the passengers of the vehicle may be rescued more quickly. The previously described measures do not all have to be implemented when a lateral position or a roof position of vehicle 100 is detected; rather, for example, if a lateral position of vehicle 100 is detected, it is also possible to release only the door lock 161 or 162 whose associated doors are not blocked by the tipped-over vehicle. In another specific embodiment, it is also possible to switch off motor 180 in particular in the event of a roof position of vehicle 100, since in this case none of the driven wheels have road grip and all are able to turn.

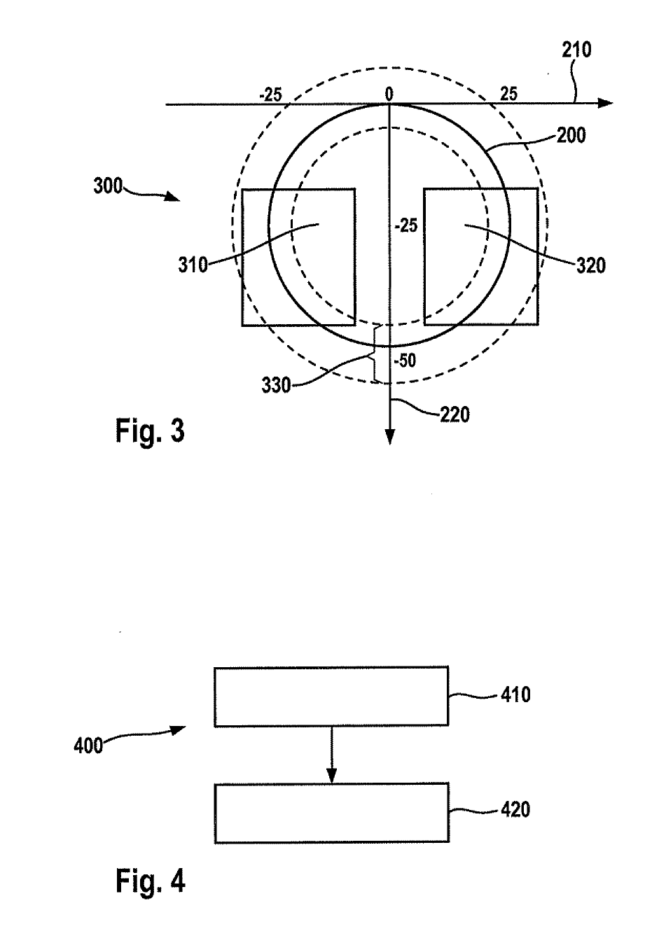

In the following, the ascertainment of the lateral position and of the roof position of the vehicle in accordance with one exemplary embodiment of the present invention is described in more detail with the aid of FIGS. 2 and 3. These figures show the basic principle of the FIS functions in different diagrams.

FIG. 2 shows a qualitative diagram of an exemplary embodiment of the present invention, in which the detection of the roof position of a vehicle is illustrated. The acceleration in the lateral direction is represented on a y axis 210 pointing toward the right, and the vertical acceleration is shown on a z axis 220 pointing down. A state space is plotted by these y and z axes 210 and 220, which is used for the further considerations. The corresponding acceleration sensors 110 and 120 ascertain a lateral value 130 for the lateral acceleration and a vertical value 150 for the vertical acceleration, a position value 200 in the state space being determined from lateral value 130 and vertical value 150 using an equation described below in greater detail. All possible position values 200 that may occur in the event of a rollover are illustrated in FIG. 2 as a circular path.

The basic principle of state detection of the vehicle is that to detect the roof position, an evaluation of the signal of the acceleration sensor in the vertical direction (vertical signal) takes place such that if the vertical signal (or a feature value derived therefrom; z acceleration signal) crosses illustrated threshold 230 (vertical threshold value), a flag is set, for example, which indicates that vehicle 100 is on its roof. Thus, to detect the roof position, it is not necessary to actually determine a position value 200 on the circular path; rather, it is only necessary to evaluate vertical value 150 or the component of position value 200 in the direction of the vertical acceleration (i.e., in z direction). The utilization of the circular path representation in the present exemplary embodiment is therefore essentially used in FIG. 2 because a circle equation is required for the evaluation of the lateral position, and it is also possible to detect the roof position using such a circular path arrangement of position values 200. Consequently, when the circular path of position values 200 is used, both the lateral position and the roof position of vehicle 100 may be detected from vertical values 150 and lateral values 130, although this is not absolutely necessary for detecting the roof position of vehicle 100.

The lateral position may be detected by evaluating position values 200 of the circular path in accordance with FIG. 3. For this reason, a lateral position region 300 (having two partial regions 310 and 320) is provided, so that, if position value 200 determined from vertical value 150 and lateral value 130 is located in this lateral position region 300, the lateral position of vehicle 100 may be detected. Also, for example, a lateral position of vehicle 100 on the right or left side may be detected, depending on the partial region 310 and 320 in which ascertained position value 200 is located. By this means, more precise safety functions for the corresponding lateral position are possible, such as the release of corresponding doors that are not blocked by vehicle 100, for example. Also, an overlap region between the corresponding roof position region and lateral position region may be provided, so that it is possible to detect, for example, that the vehicle is situated on its roof, “in a tilted manner.”

The lateral position detection may thus be described in general by the following relationship: If y acceleration signal 130 and the calculated signal from z cross the state space in a lateral position region (in accordance with reference symbols 300, 310, and 320 in FIG. 3), then a flag is set that indicates the lateral position of the vehicle.

In order to obtain greater certainty that vehicle 100 is actually lying on its roof or on its side, a timer may also be started when position value 200 or one of the corresponding vertical values 150 or lateral values 130 is located in the region of the state space that characterizes a roof position or a side position. If after a predefined roof-position time period (of 1 s, for example) position value 200 or vertical value 150 is still in the region of the state space that characterizes a roof position (i.e., in the region having absolute values on the z axis that are greater than vertical threshold value 230), then it is detected that vehicle 100 is lying on its roof. If position value 200 is still within lateral position region 300 after a predefined lateral-position time period (of 1 s, for example), in particular if it is still in the partial region 310, 320 of the lateral position region in which it was located at the beginning of the time measurement, the lateral position of vehicle 100 is detected. It is thus ensured that the corresponding safety devices, that possibly are irreversibly triggered, are not used unnecessarily when the vehicle is still in the process of rolling over, for example.

The state decision may thus be generally viewed as being based on the following equations:
Roof position detection:

RoofFlag=(—Acc_{z}, <Par_FISAccZ) & (Timer1>Par_Time1 Value) (1)
Lateral position detection:
Offset=FISOffset

Y²=[(Acc₂, +FISOffset)²−(Radius)²] (2)

LateralFlag=[(−Y²<FISCircleY)&(|YgemSign.|>FISY)]& (Timer1>Par_Timer1Value) (3)

where the variable “RoofFlag” designates the flag for indicating a roof position, “Acc_{z}” designates the flag for indicating an acceleration or a value derived therefrom in the vertical (i.e., z) direction, “Par_FISAccZ” designates a vertical threshold value starting from which the attainment of a roof position of the vehicle is to be detected, “&” designates a logical AND link, “Timer1” designates a measurement counter state of the timer, “Par_Timer1Value” designates a predefined roof-position time period and/or a lateral-position time period after which a roof position or a lateral position is to be detected, “Offset” designates a variable for taking into account an offset value in the vertical direction, “FISOffset” designates a predefined offset in the z direction, which is caused, for example, by gravity, and the disregarding of which would result in an erroneous determination of the roof position or lateral position, and “LateralFlag” designates the flag for indicating that the vehicle has a lateral position. The “radius” variable illustrates a radius of the circle which is known for the ideal case. The “FISY” variable represents a threshold value for the measured y (or Y) signal. The “YgemSign.” variable represents a measured Y signal. The “FISCircleY” variable represents a calculated Y² signal from the measured z (or Z) signal.

The previously mentioned offset correction is required in order to shift the circle to the zero point of the coordinate system, since the sensors reset in the normal state of the vehicle. This is not necessary for the y direction, and for the z direction an acceleration (offset) of 1 g should be taken into account.

Y² reflects a calculated Y signal, which is then verified using the measured Y value (i.e., “YgemSign.”). Y² defines the state space that is used for the lateral detection. The sign of the measured y signal defines the side that is detected as the lateral position of the vehicle. The square of the measured Y signal is compared to the calculated Ŷ2. The calculated signal must be situated in a confidence region around the measured Ŷ2. The confidence region may be defined by parameters.

Alternatively, it is possible to determine the state space for the lateral detection without equation 2. For this purpose, the measured Y signal (“YgemSign.”) should be used for Y² and the parameter “FISKreisY” should be calibrated to the corresponding values.

These functions use the circle equation (3) for the state detection of the lateral position.

To verify whether the vehicle is now once again on its wheels or has assumed a stable position on its roof/side, a second timer (i.e., a second time measurement device) is started as soon as condition (1) or (2) is fulfilled. The second timer runs for an adjustable time period. After the time has run out, conditions (1) and (2) are checked once again. If they are fulfilled, then the vehicle has stabilized on its side/roof; if they are no longer (both) fulfilled, it may be assumed that the vehicle is neither in the roof position nor in the lateral position, but rather is once again on its wheels (i.e., in the normal position).

An additional option for improving the vehicle state detection via acceleration sensors would be the definition of maximum and minimum radii, related to a defined circle. The current radius for the lateral and vertical values may be calculated easily from y and z vectors using the Pythagorean theorem. If the calculated radius (i.e., the position values) is in a ring-shaped minimum-maximum band, as represented by band 330 in FIG. 3, the vehicle state may be determined by previously mentioned threshold values. The limitation (i.e., the confidence region of the signals) is thus already determined through the definition of the inner and outer circle. The signals provided by the acceleration sensors can be plausibilized by this means, so that an erroneous provision of acceleration sensor signals does not lead to a triggering of the safety devices.

FIG. 4 shows a flow chart of an exemplary embodiment of the present invention as a method. Method 400 for detecting a lateral position and/or a roof position of a vehicle may be implemented in a vehicle that has a lateral acceleration sensor that is designed to determine a lateral acceleration of the vehicle and to output a corresponding lateral value. Furthermore, method 400 may be implemented in a vehicle that has a vertical acceleration sensor that is designed to determine a vertical acceleration of the vehicle and to output a corresponding vertical value. The method includes a first step of receiving 410 the lateral and/or vertical value. In a second step 420, the roof position of the vehicle is detected if a position value derived from the vertical value is greater in absolute terms, at least in one component, than a predefined vertical threshold value, and/or the lateral position of the vehicle is detected if a position value derived from the vertical value and the lateral value is located in a lateral position region of a state space, the state space being plotted by axes relative to a lateral and a vertical acceleration.

1-12. (canceled)

13. A method for detecting a lateral position and/or a roof position of a vehicle, the method comprising:
receiving at least one of a lateral value and a vertical value via an interface, the lateral value representing a lateral acceleration, and the vertical value representing a vertical acceleration; and
at least one of: i) detecting the roof position of the vehicle if the vertical value a position value derived from the vertical value is greater in absolute terms, at least in one component, than a predefined vertical threshold value, and ii) detecting the lateral position of the vehicle if a position value derived from the vertical value and the lateral value is located in a lateral position region of a state space, the state space being plotted by axes relative to a lateral and a vertical acceleration.

14. The method as recited in claim 13, wherein in the detecting step, the position value is determined by using a circle equation.

15. The method as recited in claim 13, wherein in the step of detecting the lateral position, a lateral position region in the state space is used whose components in a direction of a vertical acceleration have a lower absolute value than the vertical threshold value.

16. The method as recited in claim 13, wherein a lateral position region divided into a first and a second partial region is used in the step of detecting the lateral position, in order to detect that the vehicle is lying on a first side when the position value is in the first partial region, and to detect that the vehicle is lying on a second side, which is opposite the first side, when the position value is in the second partial region, components of the first partial region in a direction of the lateral acceleration having a different sign than corresponding components of the second partial region.

17. The method as recited in claim 13, wherein in the detecting step a position value is used, in which at least one of: i) a lateral offset value for the lateral value is taken into account, and ii) a vertical offset value for the vertical value is taken into account.

18. The method as recited in claim 15, wherein during the detecting step, at least one of: i) the lateral position is detected when the position value is in the lateral position region of the space state for a predefined lateral-position time period, and ii) the roof position is detected when the vertical value or the position value assumes a value that is greater than the vertical threshold value in at least one component for a predefined roof-position time period.

19. The method as recited in claim 18, wherein an upright position of the vehicle is detected in the detecting step at least one of: i) when the position value has been in the lateral position region but is no longer in the lateral position region after the predefined lateral-position time period, and ii) when at least one component of the position value has assumed a value greater than the vertical threshold value, but after the predefined roof-position time period the at least one component has assumed a value that is no longer greater than the vertical threshold value.

20. The method as recited in one of claim 13, wherein in the detecting step, at least one of the lateral position and the roof position are detected only if the position value is located within a predefined ring-shaped region in the state space.

21. The method as recited in one of claim 20, further comprising:
activating a safety function if a lateral position or a roof position of the vehicle was detected in the detecting step.

22. The method as recited in one of claim 13, wherein in the receiving step, the at least one of the lateral value and vertical value are received by a value memory.

23. A storage device storing a computer program, the computer program, when executed by a control unit, causing the control unit to perform the steps of:
receiving at least one of a lateral value and a vertical value via an interface, the lateral value representing a lateral acceleration, and the vertical value representing a vertical acceleration;
at least one of: i) detecting the roof position of the vehicle if the vertical value or a position value derived from the vertical value is greater in absolute terms, at least in one component, than a predefined vertical threshold value, and ii) detecting the lateral position of the vehicle if a position value derived from the vertical value and the lateral value is located in a lateral position region of a state space, the state space being plotted by axes relative to a lateral and a vertical acceleration.

24. A control unit configured to detect a lateral and/or a roof position of a vehicle by performing the steps of:
receiving at least one of a lateral value and a vertical value via an interface, the lateral value representing a lateral acceleration, and the vertical value representing a vertical acceleration; and
at least one of: i) detecting the roof position of the vehicle if the vertical value or a position value derived from the vertical value is greater in absolute terms, at least in one component, than a predefined vertical threshold value, and ii) detecting the lateral position of the vehicle if a position value derived from the vertical value and the lateral value is located in a lateral position region of a state space, the state space being plotted by axes relative to a lateral and a vertical acceleration.
